(19) United States
(12) Patent Application Publication
(10) Pub. No.: US 2022/0001304 A1
(43) Pub. Date: Jan. 6, 2022

(54) HYDROXYETHYL CELLULOSE DERIVATIVE FOAM CONTROL AGENTS AND METHODS OF PROCESSING FOODSTUFFS

(71) Applicant: Doe Global Technologies LLC, Midland, MI (US)

(72) Inventors: Xue Chen, Lake Jackson, TX (US); Roland Bayer, Bomlitz (DE); Jin Zhao, Midland Lab, MI (US)

(21) Appl. No.: 17/280,150

(22) PCT Filed: Sep. 17, 2019
(86) PCT No.: PCT/US2019/051439

§ 371 Date: Mar. 25, 2021

Related U.S. Application Data
(60) Provisional application No. 62/738,421, filed on Sep. 28, 2018.

(51) Int. Cl. B01D 19/04; C08L 1/28; A23L 5/00; A23L 19/12; A23L 19/00; A23N 12/02

(52) U.S. Cl. CPC B01D 19/0495; C08L 1/284; A23L 5/00; A23V 2002/00; A23L 19/09; A23N 12/023; B01D 19/0468; A23L 19/12

(57) ABSTRACT

Cellulose derivatives comprising a hydroxyethyl group, such as hydroxyethyl methyl cellulose, are used as foam control agents in foodstuff processing. The cellulose derivatives are biodegradable while still providing excellent foam control capacity. In addition, cellulose derivatives foam control agents of the disclosure can be used with various apparatus while avoiding forming films that otherwise affect apparatus function. The cellulose derivatives can be used at various stages during industrial processing of vegetables (e.g., potatoes and beets) and fruits.

### RELATED APPLICATION

The present application claims the benefit of commonly owned provisional Application having Ser. No. 62/738,421, filed on Sep. 28, 2018, which provisional application is incorporated herein by reference in its entirety.

### BACKGROUND

The processes for manufacturing foodstuffs occasionally cause unwanted foam generation. Mechanical methods of foam management have limited effectiveness. Instead, foam control agents are added to the manufacturing process to reduce foam generation. For food and pharma applications, traditional foam control agents include ethylene oxide-based, propylene oxide-based and silicone-based agents. Foam control agents include foam inhibitors that prevent the formation of foam (antifoamers), and defoamers that reduce foam after it is formed.

Undesirable foam formation can occur at various processing stages during the processing of a vegetable, fruit, or plant foodstuff. For example, during industrial processing of sugar beet (such as leading to formation of sugar, syrups, and juices), foam formation can occur in processing equipment during washing, cutting, diffusing, carbonizing, and evaporation steps. Likewise, during industrial processing of potatoes, foam formation can occur in processing equipment during washing, cleaning, polishing, and cutting. Yet other processes using foodstuffs where foam control is desirable includes industrial fermentation processes, including fermentation for the producing of nutraceuticals and pharmaceuticals.

Foam control agents desirably do not have an adverse effect on the industrial processes they are used in to control foam, including adverse effects on microorganisms used in industrial fermentation of foodstuffs. Since foam control agents may in some instances become present in the end product of the foodstuff processing procedure, it is desirable that they are physiologically and safe. Also, foam control agents that are present in water compositions which are disposed of are preferably biodegradable and environmentally safe. However, many conventional foam control agents used for food processing are not biodegradable.

### SUMMARY

Aspects of the current invention are directed to methods for controlling foam during foodstuff processing using cellulose derivatives, food product precursor compositions including cellulose derivatives, and systems for processing foodstuffs configured for using cellulose derivatives and controlling foam formation.

In embodiments, the invention provides a method for controlling foam while processing a foodstuff. The method includes steps of (a) forming a composition comprising a foodstuff and a cellulose derivative comprising a hydroxyethyl group, and (b) processing the composition. In the method the cellulose derivative is capable of reducing or preventing foaming during processing.

In other embodiments, the invention provides a food product precursor composition, the compositing including (a) a foodstuff; and (c) a cellulose derivative comprising a hydroxyethyl group.

In other embodiments, the invention provides system for processing a food stuff using a cellulose derivative of the disclosure. The system includes (a) a foodstuff processor capable of one or more of washing, cutting, chopping, grating, slicing, peeling, julienning, mincing, dicing, shredding, blending, pureeing, beating, liquidizing, mashing, whisking, crushing, juicing, grinding, and fermenting a foodstuff to a processed foodstuff, (b) a container configured to hold the cellulose derivative and the processed foodstuff and (c) a separator mechanism capable of separating the foam control agent from the processed foodstuff.

Exemplary cellulose derivatives that can be used in conjunction with the methods, compositions, and systems of the disclosure include hydroxyethyl methyl cellulose (HEMC). Desirably, the cellulose derivative has a viscosity less than 10000 cps, less than 5000 cps, and most desirably in the range of about 0.1 cps to about 500 cps. The methods, compositions, and systems that use the cellulose derivative foam control agents of the disclosure can be used for the processing of various types of plants, fruits, or vegetables, such as those that include substantial amounts of starch, such as potatoes, or substantial amounts of saponin, such as beets. Release of starch and saponin from these foodstuffs can otherwise cause formation of foam, which is controlled using the cellulose derivatives of the disclosure.

Cellulose derivatives foam control agents of the disclosure provide advantages over other conventional foam control agents in that they are biodegradable while still providing excellent foam control capacity. In addition, cellulose derivatives foam control agents of the disclosure can be used with various apparatus while avoiding forming films that otherwise affect apparatus function (such as films on screens and filters during a filtration process).

### BRIEF DESCRIPTION OF THE DRAWINGS

FIG. 1 is a schematic diagram illustrating steps in the industrial processing of sugar beets.

FIG. 2 is a schematic diagram illustrating steps in the industrial processing of potatoes.

### DETAILED DESCRIPTION

The present disclosure describes methods, compositions, and systems for controlling foam. The methods, compositions, and systems described herein are particularly relevant to food processing applications. During food-processing foam can be generated at various points in the production process. The foam is caused by the presence of surface-active substances such as proteins, fatty acids, polysaccharides such as starch, saponins, and sugars when aeration (generated for example by mechanical agitation, mixing, washing, extraction, stirring, sparging, etc.) occurs during processing. Foam impairs the food processing process in many different ways and greatly disrupts the process flow. The methods described herein are effective in limiting the amount of foam generated in a food processing application as compared to a similar food process where the methods described herein are not used. Without being limited by theory, it is expected that the methods of the present disclosure have features that both (1) limit the amount of foam generated in a food process (also known as anti-foam agents) and (2) minimize or eliminate generated foams (also known as defoaming agents). The food composition and the foam control agent are combined as is known in the art, for example, by mixing.

Foam control agents of the disclosure can be used at a single point in a food processing operation, or can be used at more than one point during the procedure. For example, the industrial processing of some vegetable, fruits, or plants can involve processing steps such as washing, peeling, size reduction (e.g., cutting, shredding, blending, etc.), diffusion, extraction, and fermentation. Foam control agents of the disclosure can be used in any one or more of these particular processing steps, and formulated as desired in compositions suitable for each type of processing event.

Foam control agents of the disclosure include cellulose derivatives comprising a hydroxyethyl group, which is a type of hydroxylalkylated celluloses. Such cellulose derivatives are synthetically prepared by at least hydroxyalkylation, and are therefore “non-natural” compounds. Since modification of the cellulose results in formation of an ether group, cellulose derivatives of the disclosure can also be referred to herein as “cellulose ethers.”

Cellulose is a naturally-occurring polysaccharide having a linear chain of several hundred to many thousands of β(1→4) linked D-glucose units as follows:

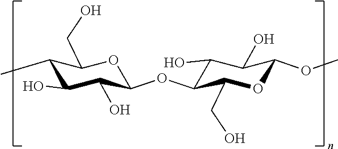

In modified cellulose, one or more of the hydroxyl hydrogens of cellulose are replaced with a group(s) that includes one or more atoms that are different than hydrogen. Cellulose derivatives/cellulose ethers of the current disclosure that include a hydroxyethyl group includes a unit of Formula I:

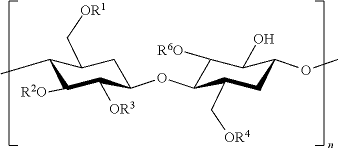

wherein R¹, R², R³, R⁴, R⁵, and R⁶ are independently selected from H, —CₓH_{y}, and —(C₂H₄O)ₘH, with the proviso that at least one of R¹, R², R³, R⁴, R⁵, and R⁶ is —(C₂H₄O)ₘH, and preferably at least one of R¹, R², R³, R⁴, R⁵, and R⁶ is —C₂H₄OH. The cellulose derivative is also preferably alkylated (i.e., the cellulose derivative is hydroxyalkylated and alkylated). Therefore, in preferred embodiments in the cellulose derivative R¹, R², R³, R⁴, R⁵, and R⁶ are independently selected from H, —CₓH_{y}, and —(C₂H₄O)ₘH, with the proviso that at least one of R¹, R², R³, R⁴, R⁵, and R⁶ is —(C₂H₄O)ₘH, such as —C₂H₄OH, and at least one of R¹, R², R³, R⁴, R⁵, and R⁶ is —CₓH_{y}, such as —CH₃.

Exemplary cellulose derivatives are hydroxyethyl cellulose, hydroxyethyl alkylated cellulose (also known as “alkylated hydroxyethyl cellulose”), and preferably hydroxyethyl methyl cellulose (HEMC; also known as “methyl hydroxyethyl cellulose”).

In exemplary —(C₂H₄O)ₘH groups, m is an integer and is preferably 1, but can be greater than one (e.g., such as 2, 3, 4, 5, or 6) if a hydoxylalkating agent is used in molar excess to the target hydroxyl group(s) on the cellulose.

In exemplary —CₓH_{y}, groups, x is an integer in the range of 1 to 6, y is an integer in the range of 2 to 13. Preferably x is 1 and y is 3. Cellulose derivatives can also include two or more different —CₓH_{y}, groups. For example, at least one of R¹, R², R³, R⁴, R⁵, and R⁶ is —C₂H₄OH, and at least two of R¹, R², R³, R⁴, R⁵, and R⁶ are —CH₃ and —CₓH_{y} groups, with, x being an integer in the range of 2 to 6, and y being an integer in the range of 4 to 13.

Substitution with at least one —CₓH_{y} or —(C₂H₄O)ₘH group can be defined in terms of degree of substitution, molar substitution, or both degree of and molar substitution.

The “degree of substitution” (DS) is the average number of positions substituted per glucopyranose ring. Since each glucopyranose monomer unit in the cellulose polymer has three hydroxyls available for modification, DS values range from zero to three (full substitution). For cellulose derivatives having a DS of less than 1, not all glucopyranose monomer units of the cellulose derivative may have modification with the hydroxylethyl group, or the hydroxylethyl and alkyl (e.g., methyl) groups. For example, the a cellulose derivative can have unit(s), wherein all of R¹, R², R³, R⁴, R⁵, and R⁶ are all H, and unit(s), wherein one, or more than one, of R¹, R², R³, R⁴, R⁵, and R⁶ are —(C₂H₄O)ₘH, or —(C₂H₄O)ₘH and CₓH_{y}, such as —CH₃.

The “molar substitution” (MS) is the average number of substituents per glucopyranose ring. In some modes of preparing the cellulose derivative, the derivatization process does not have more than one substituent per position on the glucopyranose ring. In other cases where there is more than one substituent per position on the glucopyranose ring, an epoxide used to form the derivative reacts with a hydroxy group forming terminal alkoxide, and the formed terminal alkoxide can be more reactive than the cellulosic hydroxyl groups, as the formed terminal alkoxide is more distant from the bulky polymer backbone. In this reaction scheme, chain extension the off the formed terminal alkoxide can be favored over simple substitution cellulosic hydroxyl groups. Therefore, in this chain extension mode of synthesis, the molar substitution can be greater than the degree of substitution (MS>DS). However, in preferred aspects of the disclosure, it is preferred that in the cellulose derivatives the molar substitution is limited so that DS is equal to MS or DS is greater than MS.

Methyl cellulose does not occur naturally and is synthetically produced by heating cellulose with caustic solution (e.g. a solution of sodium hydroxide) and treating it with methyl chloride. Cellulose or methyl cellulose can be reacted with ethylene oxide to provide hydroxyethyl groups. In the substitution reaction that follows, the hydroxyl residues (—OH functional groups) are replaced by methoxide (—OCH₃ groups). U.S. Pat. Nos. 3,709,876 and 3,769,247 describe a two-step synthesis of cellulose ethers consisting of the methylation of cellulose with methyl chloride, followed by ethoxylation to produce hydroxyethyl methyl cellulose (HEMC).

Cellulose derivatives having varying degrees of substitution and varying degrees of molar substitution with hydroxyethyl and methyl groups are known in the art. Reference is made to the following documents, whose disclosure is incorporated herein by reference. For example, U.S. Pat. No. 9,051,218 (Kiesewetter, et al.), describes cellulose ethers including hydroxyethyl methyl cellulose (HEMC) wherein the DS of methoxy groups is in the range of 1.2 to 2.2, in the range of 1.25 to 2.10, or in the range of 1.4 to 2.0, and a molar substitution of hydroxylalkoxy (e.g., forming hydroxyethyl) in the range of 0.11 to 1.0, in the range of 0.12 to 0.8, or in the range of 0.14 to 0.5. HEMC polymers were prepared by reaction of wood cellulose pulp using dimethyl ether, methyl chloride, sodium hydroxide, and ethylene oxide in a two stage reaction (Examples 1-4 of U.S. Pat. No. 9,051,218).

U.S. Pat. No. 9,346,712 (Baumann, et al.), describes HEMC having a MS that is greater than 0.01, 0.05 or greater, 0.1 or greater, and 0.18 or greater, and also 0.5 or less, 0.4 or less, 0.35 or less, and 0.33 or less. The HEMC is also described as having a DS greater than 1.65, 1.70 or greater, 1.72 or greater, and 1.8 or greater, and also less than 2.2, 2.0 or less, or 1.9 or less.

U.S. Patent App. Pub. No. 2013/0193370 (Adden, et al.) describes cellulose ethers having a DS(methyl) of from 1.2 to 2.2, from 1.25 to 2.10, and 1.40 to 2.00, and a MS (hydroxyalkyl, e.g., hydroxyethyl) of 0.11 to 1.00, 0.13 to 0.80, 0.15 to 0.70, 0.18 to 0.60, and 0.18 to 0.50.

International Publication Number WO 2013/026657 describes polysaccharide derivatives, and shows exemplary HEMC and hydroxyethyl ethyl cellulose (HEEC) structures on pages 10 and 11, respectively. DS values in the range of 1.0 to 3, 1.5 to 3, and 2.0 to 3.0, are described.

The cellulose derivatives of the disclosure can be described in terms of viscosity. Viscosity is commonly measured in units Poise (P) or centipoise (cP), or Pascal seconds (pa.s.) using equipment such as a rotating spindle instrument, such as a Brookfield viscometer (Brookfield Engineering Laboratories, Middleboro, Mass.). The amount of force that is needed to turn the spindle (torque) is recorded in Poise (P) or centipoise (cP) (1.0 P=0.1 Newton-seconds/m²). The glass capillary viscometer is the standard instrument for measuring viscosity of Newtonian fluids and is calibrated with reference to the defined value of the viscosity of water. In Formula I n can be an integer to provide cellulose derivatives with a viscosity value in a range as described herein.

In embodiments, the cellulose derivative has a viscosity in the range of about 0.1 cps to about 10000 cps as measured at a concentration of 2% (wt) in water at 20° C. In even more preferred embodiments the cellulose has a viscosity in the range of about 0.1 cps to about 5000 cps as measured at a concentration of 2% (wt) in water at 20° C. In even more preferred embodiments the cellulose has a viscosity in the range of about 0.1 cps to about 500 cps as measured at a concentration of 2% (wt) in water at 20° C.

The viscosity of the cellulose derivative can be adjusted, e.g., lowered, by using a treatment such as partial depolymerization. For example, partial depolymerization of HEMC can be carried out by heating a HEMC preparation with gaseous hydrogen chloride at a temperature of 60-85° C. for 80-100 min. See, for example, International Publication Number WO 2016/200673 (Bayer, et al.) and U.S. Patent App. Pub. No. 2016/0318813 (Bayer, et al.)

Hydroxylalkylated and alkylated celluloses, e.g., HEMC, are commercially available under the tradename WALOCEL™, all from the Dow Chemical Company.

The cellulose derivative foam control agent of the disclosure can be in a form configured to be added to a composition that includes a foodstuff or a product derived from a foodstuff product. For example, the cellulose derivative foam control agent can be in the form of a solids composition, such as in powder or granule form, that is added to an aqueous composition that includes the foodstuff or a product derived therefrom. Alternatively, the foam control agent can be in a liquid composition, such as a liquid concentrate, which can be added to an aqueous composition that includes the foodstuff. Such composition forms can be “stock” or “concentrated” compositions that, when a desired amount is added to a composition that includes the foodstuff, provides the cellulose derivative foam control agent in a working amount.

A stock or concentrated liquid composition can further include a solvent, a surfactant, an emulsifier, or a combination thereof. The cellulose derivative can be in a dissolved or suspended form in such a liquid composition. An optional surfactant or emulsifier can be in an amount in the range of 0.1-30% by weight of the composition.

Exemplary optional surfactant(s) or emulsifier(s) are anionic, cationic and nonionic compounds. Examples of suitable anionic surfactants or emulsifiers are alkali metal, ammonium and amine soaps; the fatty acid part of such soaps contains preferably at least 16 carbon atoms. The soaps can also be formed “in situ;” in other words, a fatty acid can be added to the oil phase and an alkaline material to the aqueous phase.

Other examples of suitable anionic surfactants or emulsifiers are alkali metal salts of alkyl-aryl sulfonic acids, sodium dialkyl sulfosuccinate, sulfated or sulfonated oils, e.g., sulfated castor oil; sulfonated tallow, and alkali salts of short chain petroleum sulfonic acids.

Suitable cationic surfactants or emulsifiers are salts of long chain primary, secondary or tertiary amines, such as oleylamide acetate, cetylamine acetate, di-dodecylamine lactate, the acetate of aminoethyl-aminoethyl stearamide, dilauroyl triethylene tetramine diacetate, 1-aminoethyl-2-heptadecenyl imidazoline acetate; and quaternary salts, such as cetylpyridinium bromide, hexadecyl ethyl morpholinium chloride, and diethyl di-dodecyl ammonium chloride.

Examples of suitable nonionic surfactants or emulsifiers are condensation products of higher fatty alcohols with ethylene oxide, such as the reaction product of oleyl alcohol with 10 ethylene oxide units; condensation products of alkylphenols with ethylene oxide, such as the reaction product of isoctylphenol with 12 ethylene oxide units; condensation products of higher fatty acid amides with 5, or more, ethylene oxide units; polyethylene glycol esters of long chain fatty acids, such as tetraethylene glycol monopalmitate, hexaethyleneglycol monolaurate, nonaethyleneglycol monostearate, nonaethyleneglycol dioleate, tridecaethyleneglycol monoarachidate, tricosaethyleneglycol monobehenate, tricosaethyleneglycol dibehenate, polyhydric alcohol partial higher fatty acid esters such as sorbitan tristearate, ethylene oxide condensation products of polyhydric alcohol partial higher fatty acid esters, and their inner anhydrides (mannitol-anhydride, called Mannitan, and sorbitol-anhydride, called Sorbitan), such as glycerol monopalmitate reacted with 10 molecules of ethylene oxide, pentaerythritol monooleate reacted with 12 molecules of ethylene oxide, sorbitan monostearate reacted with 10-15 molecules of ethylene oxide, mannitan monopalmitate reacted with 10-15 molecules of ethylene oxide; long chain polyglycols in which one hydroxyl group is esterified with a higher fatty acid and other hydroxyl group is etherified with a low molecular alcohol, such as methoxypolyethylene glycol 550 monostearate (550 meaning the average molecular weight of the polyglycol ether). A combination of two or more of these surfactants may be used; e.g., a cationic may be blended with a nonionic or an anionic with a nonionic.

The foam control agent composition can optionally include one or more additive(s). Examples of additives include ethylene oxide/propylene oxide block copolymers, butylene oxide/propylene oxide block copolymers, ethylene oxide/butylene oxide block copolymers, waxes, or silicone-based materials.

The foam control agent composition can optionally include one or more secondary foam control compounds that are used in conjunction with the methods, compositions, or systems that include the cellulose derivative foam control agent. Optional secondary foam control agents that are different than the cellulose derivative foam control agents of the disclosure include one or more agents produced by the alkoxylation of alcohol(s); at least one alkyl polyglucoside (APG); foam control agents described in one or more of Assignee's co-pending U.S. Provisional Patent Application Ser. No. 62/644,015 filed Mar. 16, 2018, in the name(s) of Xue Chen, and having Attorney Docket No. 81861-US-PSP; U.S. Ser. No. 62/644,024 filed Mar. 16, 2018, in the name(s) of Michael L. Tulchinsky, and having Attorney Docket No. 81862-US-PSP; U.S. Ser. No. 62/644,031 filed Mar. 16, 2018, in the name(s) of Clark H. Cummings, and having Attorney Docket No. 81863-US-PSP; and U.S. Ser. No. 62/644,038 filed Mar. 16, 2018, in the name(s) of Stephen W. King, and having Attorney Docket No. 81864-US-PSP; the disclosures of these applications incorporated herein. Other optional secondary foam control agents that are different than the cellulose derivative foam control agents of the disclosure also include foam control agents described in Assignee's co-pending U.S. Provisional Patent applications filed concurrently herewith and that are identified as U.S. Provisional application titled CYCLIC KETAL COMPOUNDS HAVING LONG SIDE CHAINS USEFUL AS FOAM CONTROL AGENTS IN THE MANUFACTURE OF FOOD AND BEVERAGE PRODUCTS, having Attorney Docket No. 82301-US-PSP (DOW0096P1), in the names of Xue Chen et al., and U.S. Provisional application titled ALKYL ETHER AMINE FOAM CONTROL COMPOUNDS AND METHODS OF PROCESSING FOODSTUFFS, having Attorney Docket No. 82299-US-PSP (DOW0097P1), both disclosures incorporated herewith in their entireties.

These optional secondary foam control agents can be used in the same composition along with the cellulose derivative food control agent of the disclosure at one or more points in a food processing operation, or can be used at one or more different points in a multi-step food processing operation. That is, for example, a different secondary foam control agent can be used in an upstream processing step (such as washing of a vegetable), whereas the cellulose derivative food control agent is used in a downstream processing step (e.g., diffusion of sugar from a vegetable pulp).

In modes of practice, the cellulose derivative foam control agent is added to water to form an aqueous composition, wherein the aqueous composition is used with a foodstuff in one or more foodstuff processing steps to control any foam that may be generated as a result of the foodstuff and the processing conditions being used. The cellulose derivative foam control agent can be used in any concentration, such as in the range of 0.01 to 5% (wt), or 0.1 to 1% (wt), as described herein, to control foam formation during processing. One or more other reagents can be present in the aqueous composition along with the cellulose derivative, depending on the particular type of foodstuff processing that is being performed.

Aspects of the disclosure can optionally be described with reference to the ability of the cellulose derivative food control agent to control foam in a composition in a processing step as compared to a composition that does not include a foam control agent, or a composition that uses a comparative compound. In an exemplary testing process, a foodstuff (such as a sugar beet) is processed (such as by blending) in an aqueous composition that includes the cellulose derivative foam control agent, and an amount of foam generated is measured, such as by measuring foam height or foam amount (mass). This is then compared to foam generated under the same processing conditions but either using no foam control agent, or using a comparative compound. Use of the cellulose derivative foam control agent can reduce the amount of foam formation by at least about 10%, or by at least about 20%, such as in the range of about 10% to about 95%, or about 20% to about 95%, as compared to a composition that does not include a foam control agent.

As used herein, a “foodstuff” refers to material that is edible or drinkable, or a material that can be processed into an edible or drinkable material. A foodstuff generally is used to refer to any material that is used in combination with a composition that includes the cellulose derivative foam control agent.

An “intermediate foodstuff” or a “precursor foodstuff” can refer to a foodstuff that is processed in a first step using a composition that includes the cellulose derivative foam control agent, but that is subjected to further processing in a second step, wherein the second step is another processing step that either produces an edible or drinkable food product, or a precursor thereof. An example of an intermediate or precursor foodstuff is a peeled potato which is peeled in the presence of the foam control agent, wherein the peeled potato is used in a second processing step that involves cutting or grating the potato into edible portions such as French fry portions, or potato flakes, and these further processed portions can be considered “food products.” An “ingredient foodstuff,” which can also be an intermediate or precursor foodstuff, refers to a foodstuff that is processed from a composition that includes the cellulose derivative foam control agent, and that is subsequently used in a foodstuff product, such as a food or beverage product. An example of an ingredient foodstuff can be sugar, such as from a sugar beet obtained using methods of the disclosure. However, sugar, such as packaged for direct consumption, can also be a food product per se. Sugar and starch foodstuffs obtained using methods of the disclosure can also be used in fermentation methods such as to provide fermented products such as fermented beverages, biofuels, and pharmaceuticals, which can be referred to herein as “foodstuff derivatives,” which may or may not be edible or drinkable food products.

Foodstuffs include, but are not limited to, edible plants, vegetables, fruits, and grains, and derivatives of edible plants, vegetables, fruits, and grains that are formed when these foods are subject to processing using methods of the disclosure.

Some foodstuffs that are commonly subject to processing include plants, vegetables, and fruits that have starch. Methods of the disclosure can be used to process plants, vegetables, and fruits include those having a starch content of greater than 0.01% (wt), greater than 0.1% (wt), or greater than 1.0% (wt).

Some foodstuffs that can be processed according to methods of the disclosure include starch in an amount in the range of 0.01% to 30% wt, non-starch carbohydrate in an amount in the range of 0.01% to 80% wt, protein in an amount in the range of 0.01% to 20% wt, and water in an amount in the range of 20% to 95% wt.

Higher starch content plants, vegetables, and fruits can have starch contents of greater than 2.5% (wt), about 5% (wt) or greater, about 7.5% (wt) or greater, or even about 10% (wt) or greater, such as in the range of about 5% to about 25% (wt), or about 10% to about 25% (wt). Use of the cellulose derivative food control agent of the disclosure can be useful for controlling foam during the processing of these plants, vegetables, and fruits, which can release starch into an aqueous processing composition and otherwise cause undesirable foam formation.

Various plants, vegetables, and fruits have high starch content, and can be used in methods of the disclosure along with the cellulose derivative foam control agent. For example, in some modes of practice, the starch-containing foodstuff is, or is derived from, a vegetable or plant selected from the group consisting of peas, corn, potatoes, beans, rice, wheat, cassava, beans, sweet potatoes, yams, sorghum, and plantain.

High-content starch foodstuffs may also be defined in terms of other components that constitute the food. For example, methods of the disclosure can also use a plant, vegetable, or fruits comprises starch in an amount in the range of 5% to 25% wt, non-starch carbohydrate in an amount in the range of 0.01% to 10% wt, protein in an amount in the range of 0.01% to 10% wt, and water in an amount in the range of 50% to 95% wt, or starch in an amount in the range of 10% to 20% wt, non-starch carbohydrate in an amount in the range of 0.1% to 5% wt, protein in an amount in the range of 0.1% to 5% wt, and water in an amount in the range of 70% to 90% wt.

Some foodstuffs that are commonly subject to processing include plants, vegetables, and fruits that have saponin. Saponins are chemically defined as amphipathic glycosides structurally having one or more hydrophilic glycoside moieties attached to a lipophilic triterpene moiety. Use of the cellulose derivative food control agent of the disclosure can be useful for controlling foam during the processing of these plants, vegetables, and fruits, which can release saponin into an aqueous processing composition and otherwise cause undesirable foam formation. Methods of the disclosure can be used to process plants, vegetables, and fruits include those having a saponin content of greater than 1 ppm. High saponin content plants, vegetables, and fruits include those having a saponin content of greater than 0.001% (wt) (10 ppm), about 0.005% (wt) (50 ppm) or greater, or about 0.01% (wt) (100 ppm) or greater, such as in the range of about 0.005% (wt) to about 0.2% (wt), or such as in the range of about 0.01% (wt) to about 0.2% (wt). Saponins are reported to be found in sugar beet at levels of 0.01% to 0.2% of beet. (See, for example, Hallanoro, H., et al. (1990). Saponin, a cause of foaming problems in beet sugar production and use. Proc. Conf Sugar Proc. Res., pp. 174-203; Earl J. Roberts, Margaret A. Clarke* and Mary An Godshall, SUGARBEET SAPONINS AND ACID BEVERAGE FLOC; Sugar Processing Research Institute, Inc., 1100 Robert E. Lee Blvd., New Orleans, La., USA 70124.)

Saponin content in various plants, vegetables, and fruits have been studied, and such food stuffs can be used in methods of the disclosure along with the cellulose derivative foam control agent. For example, in some modes of practice, the saponin-containing foodstuff is, or is derived from, a vegetable or plant selected from the group consisting of peas, corn, potatoes, beans, rice, wheat, cassava, beans, sweet potatoes, yams, sorghum, and plantain.

Saponin-containing foodstuffs may also be defined in terms of other components that constitute the food. For example, methods of the disclosure can also use a plant, vegetable, or fruits comprise saponin in an amount in the range of 1 ppm to 5% wt, starch in an amount in the range of 0.01% to 30% wt, non-starch carbohydrate in an amount in the range of 0.01% to 80% wt, protein in an amount in an amount in the range of 0.01% to 20% wt, and water in an amount in the range of 20% to 95% wt.

“Foodstuff processing” refers to a physical or chemical action that treats a foodstuff. In some cases, foodstuff processing is, or includes, a cleaning or washing procedure, or a diffusing procedure. For example, foodstuff processing that uses a cleaning or washing procedure can use a composition, such as an aqueous composition, that includes the cellulose derivative foam control agent and a foodstuff, such as a plant, vegetable, or fruit, in a whole or substantially whole form. A cleaning or washing procedure can utilize a cleaning or washing apparatus, such as a tub, tank, bin, or container that is able to hold an aqueous composition having the cellulose derivative foam control agent and whole or portions of the plant, vegetable, or fruit. The cleaning or washing apparatus can further include one or more optional features such as an agitator, a mixer, or similar device to cause the movement of the plant, vegetable, or fruit therein thereby causes cleaning by movement of the foodstuff and the aqueous composition. The cleaning or washing apparatus can further include brushes or sprayers to facilitate removal of debris, such as dirt, waxes, residues, microorganisms, or other undesirable material, from the plant, vegetable, or fruit. The cleaning or washing apparatus can further include a feature, such as a strainer, sieve, filter, grate, colander, that facilitates separation of the washed or cleaned foodstuff from the aqueous composition containing the cellulose derivative foam control agent. For example, see FIG. 9 of U.S. Pat. No. 2,838,083 (the disclosure of which is incorporated herein by reference), which describes a vegetable peeler and cleaner (e.g., for potato) having spray disperser, abrasive surface of disk 50 to remove skin of the potato, and basket or strainer 185 for potato portions.

During the cleaning or washing procedure, the cellulose derivative can prevent and/or reduce formation of foam that may otherwise result from release of components (e.g., starches, saponin) from the plant, vegetable, or fruit into the aqueous wash composition. An aqueous wash or cleaning composition can include the cellulose derivative at a desired concentration, such as in the range of 0.01 to 5% (wt), or in the range of 0.1 to 1% (wt) in the aqueous wash composition. An aqueous wash or cleaning composition can optionally include one or more other reagents such as surfactant(s), antimicrobial agents, acid(s), oxidant(s), buffer(s), etc. The aqueous wash or cleaning composition can be used in a desired amount relative to the foodstuff being washed or cleaned. For example, the aqueous wash or cleaning composition is desirably at least about 20% of the composition that includes the foodstuff and the aqueous liquid portion including cellulose derivative antifoam agent. Typically, a cleaning or washing process uses aqueous liquid portion in an amount in the range of 25-90% (wt), and a foodstuff portion in an amount in the range of 10-75% (wt). Washing can be performed for a desired period of time at a desired temperature to ensure that the foodstuff is properly cleaned and desired properties (e.g., organoleptic) of the foodstuff are maintained. Generally, during cleaning or washing procedure a foodstuff is not processed into smaller portions.

In modes of practice, following a washing or cleaning procedure, the foodstuff can be subjected to one or more other food processing procedures (e.g., “downstream procedures”) that use a cellulose derivative antifoam agent. Such downstream procedures include, but are not limited to size portion processing, diffusion/extraction, blending/homogenizing, evaporation, and/or fermentation.

In some cases, foodstuff processing is, or includes, a procedure that physically reduces the size (size processing) of the foodstuff from a larger (e.g., original) size, to a plurality of smaller sizes. In some cases the plurality of smaller sizes that are formed by processing can be described with reference to the size of the pre-processed foodstuff (e.g., a whole potato or sugar beet). For example, the foodstuff, prior to processing, has an original, unprocessed, size, and processing comprises a mechanical action that reduces the original size of the foodstuff to foodstuff portions of sizes that are not less than are not less than 1%, not less than 10%, or not less than 50% of the original size. Alternatively, such processing can be described with reference to weights of the processed foodstuff, for example where the processed foodstuff portions have sizes that are not less than 1 gram, or not less than 5 grams.

Examples of processing techniques that can be used to generate processed foodstuff portions of such sized include cutting, chopping, grating, slicing, peeling, julienning, mincing, dicing, diffusing, and shredding. Examples of portions of foodstuffs that are formed can be plant, vegetable, and fruit chunks, slices, chips, flakes, shreds, and cubes. These types of smaller portions of foodstuffs can be made into a food product for consumption, or can be used for further downstream procedures such as diffusion/extraction, blending/homogenizing, evaporation, and/or fermentation. Foodstuff portions that are sized processed can optionally be described with reference to the shape and/or size of the foodstuff portion.

Size processing of a foodstuff can utilize apparatus having one or more features that physically reduce the size of the foodstuff from a larger size to a plurality of smaller sizes. For example, the apparatus can include one or more sharp articles such as blade(s), slicer(s), chipper(s), shredder(s), and grater(s) that are capable of cutting into a plant, vegetable, or fruit to generate smaller portions. The cutting features can be used in conjunction with one or more of a tub, tank, bin, or container to hold an aqueous composition having the cellulose derivative foam control agent, which can provide the plant, vegetable, or fruit to be cut, or which can hold the cut plant, vegetable, or fruit, or both.

During size processing, the cellulose derivative can prevent and/or reduce formation of foam that may otherwise result from release of components (e.g., starches, saponin) from the plant, vegetable, or fruit into an aqueous composition used in conjunction with size processing. An aqueous composition for size processing can include the cellulose derivative at a desired concentration, such as in the range of 0.01 to 5% (wt), or in the range of 0.1 to 1% (wt). Use of the aqueous composition may beneficially reduce or prevent oxidation of the size reduced foodstuff and can also remove foodstuff-based components that are released during the size processing. Size processing can be performed for a desired period of time at a desired temperature to ensure that the foodstuff is properly cleaned and desired properties (e.g., organoleptic) of the foodstuff are maintained. Generally, during cleaning or washing procedure a foodstuff is not processed into smaller portions.

In modes of practice, following size reduction procedure, the foodstuff can be subjected to one or more other downstream procedures that use a cellulose derivative antifoam agent. Such downstream procedures include, but are not limited to, diffusion/extraction, blending/homogenizing, evaporation, and/or fermentation.

In some cases, size processing results in foodstuff portions of sizes that are very small, such as less than 1%, less than 0.1%, less than 0.01%, or less than 0.001% of the original size of the foodstuff. Exemplary processing techniques that can produce very small portions include blending, pureeing, beating, liquidizing, mashing, whisking, crushing, juicing, and grinding. Such techniques can result in food particles sizes that are very small, such as less than 0.1 grams, less than 10 mg, less than 1 mg, or less than 100 μg. Such techniques can also result in food particles sizes that are very small, such as less than 1 mm, less than 0.1 mm, or less than 10 μm.

Size processing of a foodstuff can utilize apparatus having one or more features that physically reduce the size of the foodstuff from a larger size to a plurality of very small sizes as described herein. For example, the apparatus can include one or more sharp articles such as blender blade(s) to generate very small food product particles. These processing features can be used in conjunction with one or more of a tub, tank, bin, or container to hold an aqueous composition having the cellulose derivative foam control agent, which can provide the plant, vegetable, or fruit to be cut, or which can hold the blended, homogenized, etc. plant, vegetable, or fruit, or both. During size processing to these very small food product particles, the cellulose derivative can prevent and/or reduce formation of foam that may otherwise result from processing step, cellulose derivative concentrations as described herein can be used in the aqueous composition. After processing, foodstuff solids can be separated from the aqueous portion using separation techniques such as filtration, decanting, centrifugation, etc.

In modes of practice, following such size reduction, the foodstuff particles can be subjected to one or more other downstream procedures that use a cellulose derivative antifoam agent. Such downstream procedures include, but are not limited to, diffusion/extraction, blending/homogenizing, evaporation, and/or fermentation.

In some cases, foodstuff processing is, or includes, a procedure that diffuses one or more component(s) from a foodstuff into an aqueous composition which also includes the cellulose derivative antifoam agent. The diffusion procedure can extract desired component(s) from a plant, such as sugars, which can be refined in a subsequent processing stage. Similar to a cleaning or washing, apparatus, a diffuser apparatus can include a tub, tank, bin, or container that is able to hold an aqueous composition having the cellulose derivative foam control agent and portions of the plant, vegetable, or fruit, and also an agitator, a mixer, or similar device to cause the movement of the plant, vegetable, or fruit portion therein thereby causes cleaning by movement of the foodstuff and diffusion of the plant, vegetable, or fruit, component(s) into the aqueous composition. The process of diffusing can utilize a foodstuff that has already been processed by an upstream procedure, such as any one or more size processing procedures as described herein. That is, diffusing can use processed food stuffs ranging from larger sizes, such as chunks or slices made by cutting, to very small particles, such as made by blending. The use of foodstuff portions in the diffusing process that are smaller than the originally sized foodstuff (e.g., whole potato or beet) can improve diffusion of desired components from the food stuff to the aqueous composition that includes the foam control agent. Use of the cellulose derivative foam control agent can control the generation of foam otherwise formed during diffusion without a foam control agent. After the diffusion process is completed, the aqueous composition can be separated from the portion(s) of the foodstuff that that are not soluble in the composition.

In some cases, foodstuff processing is, or includes, a procedure that evaporates water from a composition that includes a foodstuff (such as a processed foodstuff, or product derived from a processed foodstuff such as sugar or starch) and the foam control agent. The process of evaporation can utilize a foodstuff that has already been processed by an upstream procedure, such as any one or more size processing procedures and/or diffusion procedures as described herein. For example, the composition can include a processed foodstuff or component(s) derived from the foodstuffs, such as sugar(s) or protein(s) that are obtained in a diffusion process according to the disclosure. Evaporation can use one or more physical treatment(s) such as heat or low pressure to facilitate removal of water from the aqueous composition. An evaporation apparatus can include a container that is able to hold an aqueous composition having the food product and cellulose derivative foam control agent, and features such as a vacuum and heater that are operated to cause evaporation of water from the composition. Use of the cellulose derivative foam control agent can control the generation of foam otherwise formed during evaporation without a foam control agent.

In some cases, foodstuff processing is, or includes, a procedure that ferments one or more component(s) from a foodstuff in an aqueous composition which also includes the cellulose derivative antifoam agent. The fermentation procedure can include a microorganism such as bacteria or yeast that ferments one or more compound(s) from the foodstuff, such as sugar and/or starch, to a bioproduct such as ethanol, a pharmaceutical, or an industrial chemical. The process of fermentation can utilize an intermediate or precursor foodstuff that has already been processed by an upstream procedure, such as any one or more size processing procedures, diffusion, and/or evaporation procedures as described herein. A fermentation apparatus can include features such as an impellor or agitator that causes mixing of the fermentation medium, a heater, gas supply conduit(s), etc., as commonly known in the art. Use of the cellulose derivative foam control agent can control the generation of foam otherwise formed during fermentation conditions without a foam control agent.

After fermentation, the desired bioproduct can be separated from the fermentation medium. Separation can include one or more processes such as distillation, filtration, precipitation, centrifugation, and the like. Separation can also results in the separation of the foam control agent from the desired bioproduct.

In aspects, processing the foodstuff is not a cooking process (i.e., baking, roasting, flying, grilling, etc.) which otherwise subjects the food stuff or food product to high heat.

In other aspects, the composition that includes the foodstuff and the cellulose derivative is not in the form of a dough, a flour, or a dairy product.

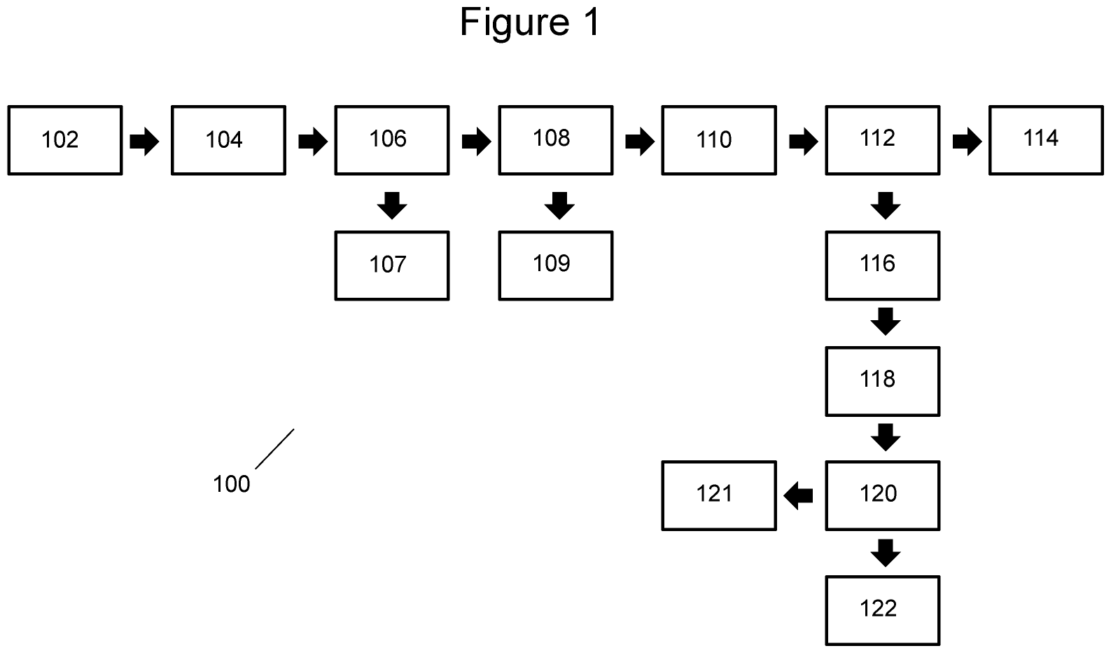

To illustrate the usefulness of the cellulose derivative foam control agent (CDFCA) in methods of processing a foodstuff, reference to FIG. 1 is made which schematically shows stages in an industrial processing 100 of a sugar beet. In stage 102 whole unprocessed beets are processed by washing in a washing tank which can include an aqueous composition with CDFCA. After washing, the washed beets are delivered to a size processing apparatus in stage 104, such as a slicing apparatus, and are size reduced in combination with an aqueous composition with CDFCA. In some cases, after size reduction the processed beet can exit the industrial processing and be used as a food product. Other size reduction steps can be included and are not included in FIG. 1. After size reduction, the washed beets are delivered to a diffusion tank in stage 106, wherein one or more components of the beet, such as sugars, are diffused into an aqueous composition that includes the CDFCA. Remaining beet material, such as beet pulps which include fibers from the plant tissue, can be separated from the sugar-containing composition, as shown in stage 107, and the pulps can be used as animal feeds. The sugar-containing composition can then be subjected to one or more refinement steps in stage 108. Generation of refinement by-products can be used for agricultural purposes in stage 109. Refined sugar composition can be subjected to evaporation in stage 110 and CDFCA can be used to control foam in this stage as well. The evaporated sugar can be subjected to crystallization and/or centrifugation in stage 112 and sent to a dryer in in stage 114. Syrups and/or sugars can also be delivered to a fermentation pathway which can involve a pre-treatment such as dilution stage 116, and then fermentation in stage 118 which uses a fermentation medium including microorganisms and CDFCA to control foam during fermenting. The fermented medium can include one or more bioproducts which can be separated by a process such as distillation in stage 120 to CDFCA to control foam during fermenting, and then the distilled product can be subjected to steps such as dehydration or rectification in steps 121 and 122.

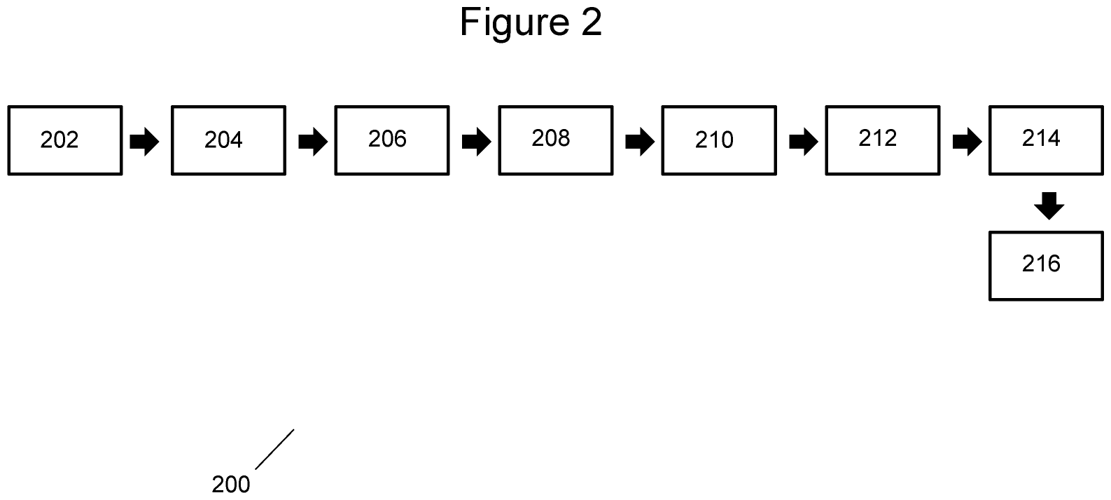

As another example to illustrate the usefulness of the cellulose derivative foam control agent (CDFCA) in methods of processing a foodstuff, reference to FIG. 2 is made which schematically shows stages in an industrial processing 200 of a potato. In stage 202 whole unprocessed potatoes are processed by washing in a washing tank which can include an aqueous composition with CDFCA. Potatoes can also be sorted at this stage. After washing and sorting, the potatoes are delivered to a peeling and/or polishing apparatus in stage 204, which can be carried out in combination with an aqueous composition with CDFCA. Next, after peeling and/or polishing, the potatoes are delivered to a size reduction apparatus, such as a cutting apparatus, in stage 206, and size reduction can be carried out in combination with an aqueous composition with CDFCA. The washed, peeled, and cut potato portions can then be subjected to various other processing steps such as chilling (stages 208 and 212), spinning/drying (stage 210), and packing (stage 214), to provide a packaged product 216.

### Examples 1-7

### Foam Control Performance Using Cellulose Derivatives

Methocel SGA 9 LV (Example 1) is a lab made sample that is degraded from Methocel SGA 16M which is commercially available grade from the Dow Chemical Company, the sample is a methylcellulose with a viscosity of 9.3 cps at 20° C. with an Ubbelohde viscosimeter and degree of substitution of 2.0.

Methylcellulose (Example 2) is synthesized according to methods known in the art. The methylcellulose sample has a viscosity of 3.5 cps at 20° C. with an Ubbelohde viscosimeter and degree of substitution of 2.0

Methocel A4M Premium (Example 3) is commercially available from the Dow Chemical Company, the sample is a methylcellulose with a viscosity of 4049 cps at room temperature and degree of substitution of 1.81.

Hydroxyethyl methylcellulose (HEMC) (Example 4) with degree of substitution of 2 and molar of substitution of 1.32, was synthesized according to methods described in U.S. Pat. No. 9,051,218 (Examples 1-4). The viscosity was determined as a 2% by weight solution in water at 20° C. in a Haake VT550 Viscotester at a shear rate of 2.55 s−1.

Hydroxyethyl methylcellulose (HEMC) (Example 5) with degree of substation of 1.62 and molar of substitution of 0.21, was synthesized according to methods described in U.S. Pat. No. 9,051,218 (Examples 1-4). The viscosity was determined as a 2% by weight solution in water at 20° C. in a Haake VT550 Viscotester at a shear rate of 2.55 s−1.

Walocel MT 400 PFV (Example 6) is commercially available from the Dow Chemical Company, which is a hydroxyethyl methylcellulose with a degree of substitution of 1.79 and molar of substitution of 0.36.

Walocel MW 400 GB (Example 7) is commercially available from the Dow Chemical Company, which is a is a hydroxyethyl methylcellulose with a degree of substitution of 1.41 and molar of substitution of 0.2.

Potatoes were washed in water, peeled and sliced. 780 g of sliced potatoes and 520 g of deionized (DI) water were added to a kitchen mixer and mixed for 1 minute. A potato slurry was generated, which was filtered through filter paper and the liquid was used to evaluate the foam control agents. This liquid is referred to as potato liquor.

Similarly, sugar beets were washed in water, peeled and sliced. 780 g of sliced sugar beets and 520 g of DI water were added to a kitchen mixer and mixed for 1 minute. A sugar beet slurry was generated, which was filtered through filter paper and the liquid was used to evaluate the foam control agents. This liquid is referred to as sugar beet liquor.

0.5 g of examples 1-7 (Part 1) were added into 99.5 g of a liquor (potato or sugar beet) to give 100 g of material for evaluation. 100 g of a liquor without any cellulose ether was used as a comparative example.

A sparge tube test was utilized to evaluate the performance of glycol ether amines as foam control agents. The “foaming control efficiency” of a material was evaluated by measuring its effect on the foam height. 100 g of each liquid example was added separately into a 1000 ml glass cylinder with a diameter of 5 cm. A vertical gas sparging tube fitted with a sintered glass frit was placed at the cylinder bottom and air was bubbled from the bottom of the cylinder. Air flow was controlled by an Ametek Lo-Flo 0-10 Float Meter with the setting at 1. Foam heights were recorded during the first 10 minutes after air flow was applied. If a foam height reached 1000 ml within the first 10 minutes, the experiment was stopped.

Tables 1 and 2 are foam heights of sugar beet liquor and potato liquor, respectively, with and without cellulose ethers as a function of time. As shown in the tables, for both potato liquor and sugar beet liquor foam mediums, the presence of cellulose ethers (examples 1-7) in the liquor controlled the foam much better than the comparative example. All of the examples were able to run for 10 minutes without exceeding 1000 ml of foam.

TABLE 1

| | comparative ex | ex 3 | ex 4 | ex 5 | ex6 | ex 7 |
|---|---|---|---|---|---|---|
| 0.5 min | 480 | 100 | 140 | 80 | 90 | 50 |
| 1 min | 600 | 130 | 160 | 90 | 110 | 60 |
| 2 min | Exceed 1000 | 180 | 310 | 130 | 170 | 110 |
| 3 min | Exceed 1000 | 260 | 450 | 190 | 250 | 190 |
| 4 min | Exceed 1000 | 350 | 560 | 260 | 320 | 250 |
| 5 min | Exceed 1000 | 460 | 640 | 320 | 400 | 320 |
| 6 min | Exceed 1000 | 520 | 640 | 350 | 460 | 370 |
| 7 min | Exceed 1000 | 630 | 660 | 380 | 550 | 450 |
| 8 min | Exceed 1000 | 710 | 690 | 400 | 630 | 520 |
| 9 min | Exceed 1000 | 800 | 720 | 420 | 700 | 580 |
| 10 min | Exceed 1000 | 860 | 770 | 460 | 780 | 640 |

TABLE 2

| | comparative ex | ex 1 | ex 2 | ex 4 |
|---|---|---|---|---|
| 0.5 min | 320 | 10 | 70 | 160 |
| 1 min | 600 | 30 | 90 | 200 |
| 2 min | Exceed 1000 | 60 | 140 | 380 |
| 3 min | Exceed 1000 | 170 | 210 | 520 |
| 4 min | Exceed 1000 | 220 | 280 | 590 |
| 5 min | Exceed 1000 | 290 | 370 | 630 |
| 6 min | Exceed 1000 | 360 | 410 | 700 |
| 7 min | Exceed 1000 | 420 | 470 | 740 |
| 8 min | Exceed 1000 | 500 | 520 | 790 |
| 9 min | Exceed 1000 | 560 | 590 | 790 |
| 10 min | Exceed 1000 | 650 | 650 | 820 |

1. A method for controlling foam while processing a foodstuff, comprising:
forming a composition comprising a foodstuff and a cellulose derivative comprising a hydroxyethyl group, and
processing the composition,
wherein the cellulose derivative comprising the hydroxyethyl group controls foam while processing the composition.

2. The method of claim 1 wherein the composition comprises water in an amount of at least 20% (wt).

3. The method of claim 2 wherein the composition comprises water in an amount in the range of 30-95% (wt).

4. The method of claim 1 wherein the step of forming comprises adding a solids composition or a liquid concentrate comprising the cellulose derivative to provide the cellulose derivative in an amount in the range of 0.01 to 5% (wt) in the composition.

5. The method of claim 4 wherein the step of forming provides the cellulose derivative in an amount in the range of 0.1 to 1% (wt) in the composition.

6. The method of claim 1 wherein the cellulose derivative has a viscosity in the range of 0.1 cps to 10000 cps as measured at a concentration of 2% (wt) in water at 20° C.

7. (canceled)

8. (canceled)

9. The method of claim 1 wherein the cellulose derivative further comprises a methyl group.

10. The method of claim 9 wherein the cellulose derivative has a degree of substitution value x, and a molar substitution value y, and x is greater than y.

11. The method of claim 10 wherein x is in the range of 1.2 to 2.2, and y is in the range of 0.11 to 1.0.

12. (canceled)

13. The method of claim 2 comprising removing water and cellulose derivative from the composition after processing.

14. (canceled)

15. The method of claim 1 wherein the foodstuff is a vegetable, fruit, or plant.

16. The method of claim 15 wherein (a) the foodstuff is or derived from a vegetable selected from the group consisting of peas, corn, potatoes, beans, rice, wheat, cassava, beans, sweet potatoes, yams, sorghum, and plantain; or (b) the foodstuff is or derived from a selected from the group consisting of beets, chickpeas, soya beans, alfalfa sprouts, navy beans, haricot beans, and kidney beans.

17-21. (canceled)

22. The method of claim 1, wherein processing comprises washing the foodstuff.

23. The method of claim 1 wherein the foodstuff, prior to processing, has an original, unprocessed, size, and processing comprises a mechanical action that reduces the original size of the foodstuff to foodstuff portions of sizes: (a) that are not less than 1% of the original size, or portions of sizes that are not less than 0.1 grams, (b) comprising a largest-sized foodstuff portion that is not less than 1% of the original size, or not less than 50% of the original size, or (c) that are not greater than 1% of the original size, or portions of sizes that are less than 0.5 grams.

24. (canceled)

25. The method of claim 1 wherein processing comprises (a) one or more action(s) selected from the group consisting of cutting, chopping, grating, slicing, peeling, julienning, mincing, dicing, diffusing, and shredding, or (b) one or more action(s) selected from the group consisting of blending, pureeing, beating, liquidizing, mashing, whisking, crushing, juicing, and grinding.

26. (canceled)

27. (canceled)

28. The method of claim 1 wherein processing comprises (a) crystalizing or purifying, or (b) fermenting.

29. (canceled)

30. (canceled)

31. The method of claim 1 wherein (a) the foodstuff is not flour, not a dough, or not a dairy product, or (b) processing does not involve cooking the foodstuff.

32. (canceled)

33. The method of claim 1, wherein the composition consists essentially of the foodstuff, the cellulose derivative, and water.

34. A food product precursor composition comprising
water,
a foodstuff comprising starch in an amount of at least 0.01% (wt) or saponin in an amount of at least 1 ppm; and
a cellulose derivative comprising a hydroxyethyl group, the cellulose derivative present in the composition in an amount in the range of 0.01 to 5% (wt).

35. A system for processing a foodstuff according to the method of claim 1 comprising:
(a) a composition comprising a foodstuff and a cellulose derivative comprising a hydroxyethyl group;
(b) a foodstuff processor capable of one or more of washing, cutting, chopping, grating, slicing, peeling, julienning, mincing, dicing, shredding, blending, pureeing, beating, liquidizing, mashing, whisking, crushing, juicing, grinding, and fermenting the foodstuff to a processed foodstuff;
(c) a container configured to hold the cellulose derivative and the processed foodstuff, and
(d) a separator mechanism capable of separating the cellulose derivative from the processed foodstuff.
